(19) United States
(12) Patent Application Publication
(10) Pub. No.: US 2015/0265099 A1
(43) Pub. Date: Sep. 24, 2015

(54) Combination Gas and Charcoal Grill

(71) Applicant: Arthur Coffie, Trenton, NJ (US)

(72) Inventor: Arthur Coffie, Trenton, NJ (US)

(21) Appl. No.: 14/218,041

(22) Filed: Mar. 18, 2014

(51) Int. Cl. A47J 37/07

(52) U.S. Cl. CPC A47J 37/0704; A47J 37/0722; A47J 37/0727

(57) ABSTRACT

A grill having multiple heating elements is provided. The grill has dual heat sources that can be used either independently from each other or simultaneously to generate differently-heated regions on the grill surface. The present grill utilizes both a vertical heating element disposed on the back interior surface of the grill housing and a horizontal heating element removably disposed within the bottom portion of the grill housing. The vertical heating element utilizes either gas, such as propane, or electricity as its fuel source. The horizontal heating element comprises a removable tray on which wood or charcoal may be placed. The vertical heating element further has a heat shield, deflecting heat therefrom, and a drip tray, preventing grease and other food particles from coming in contact with the heat source, disposed between it and the grill surface.

### BACKGROUND OF THE INVENTION

1. Field of the Invention

The present invention relates to grills. More specifically, the present invention relates to grills that utilize dual heat sources.

It can be extremely difficult to adequately control the heat generated by gas heat sources because grease and other debris from the food being cooked falls through the grill surface into the heat source. This creates flare ups, which in turn create areas of the grill that are temporarily uncontrollably heated. Temperature control is critical when cooking food properly because it is undesirable to have food that is cooked unevenly or burned. Flares ups, if large enough, can also be dangerous. Conversely, when cooking with wood or charcoal as the heat source for the grill, it is often advantageous for the grease to drip from the food being cooked onto the heat source the dripping grease can vaporize when it comes in contact with the wood or charcoal and further assist in flavoring the food being cooked on the grill. Some users may not wish to impart a wood or charcoal flavor onto their food, however. Conventional grills only utilize a single type of heat source and fail to take advantage of the inherent advantages of the different types of heat sources. If a user wishes to cook food using both gas and charcoal or wood, he or she must have two separate grills running simultaneously and then switch the food between the two grills.

Single heat source grills that use gas as the heat source generally position the gas burners directly below a grill surface. This setup has a number of issues, including the fact that grease and other food debris from the food being grilled can drop directly into the heat source, creating flare ups that are potentially dangerous and can make the food more difficult to cook properly due to uneven heating. Also, it is challenging to cook food slowly when using a conventional gas grill because there is no barrier between the heat source and the grilling surface. Single heat source grills that use charcoal or wood as the heat source, on the other hand, impart a distinct flavor to the food cooked on the grill, which some users may not always want. Each of these types of grills has inherent advantages and disadvantages. Conventional grills, which have only a single heat source, fail to utilize the advantages inherit to both types of cooking methods. Therefore, there is a need in the prior art for a grill that has both a first heat source, comprising gas or electric burners, and a second heat source, comprising a means for holding wood, charcoal, or the like, thereby allowing users to generate differently-heated regions on the grill surface. There is also a need in the prior art for a grill that simultaneously has a means for preventing grease and other food debris from falling directly into the gas or electric heat source.

In light of the disadvantages inherent in the prior art, a combination grill having multiple heating elements is provided. The present combination grill comprises a traditional grill housing, a vertical heating element, a removable horizontal heating element, a heat shield, and a catch pan for preventing grease and other food debris from falling into the vertical heating element. The vertical heating element utilizes either gas, such as propane, or electricity as its energy source. The horizontal heating element comprises a removable tray on which wood or charcoal can be supported. The vertical heating element is disposed on the interior of the back surface of the grill housing, perpendicular to the grill surface. The horizontal heating element is disposed within the bottom portion of the gill housing and is substantially parallel to the grill surface. Due to their different orientations and positions, the heating elements are able to generate complementary regions on the grill surface heated by the different heating elements, which allows users to cook food using the different heating elements depending on where the food is positioned on the grill surface.

A heat shield is preferably positioned between the grill surface and the vertical heating element to deflect heat therefrom, ensuring that the food on the grill surface is cooked solely via indirect heat. The method of cooking via indirect heat is especially suited for certain types of food, such as jerk chicken. Finally, the present combination grill has a catch pan situated between the grill surface and the vertical heating element to advantageously catch grease and other food particles, preventing them from coming in contact with the vertical heating element and thereby generating flames and an uneven temperature distribution. Conversely, the horizontal heating element is left exposed to grease and other food particles dropping from the grill surface, allowing the dripping grease to vaporize once it hits the wood or charcoal and thereby assist in flavoring the food cooked on the grill.

2. Description of the Prior Art

Devices have been disclosed in the prior art that relate to combination gas and charcoal grills. These include devices that have been patented and published in patent application publications. These devices generally relate to grills having separate gas and charcoal heat sources and corresponding separate grilling surfaces. The following is a list of devices deemed most relevant to the present disclosure, which are herein described for the purposes of highlighting and differentiating the unique aspects of the present invention, and further highlighting the drawbacks existing in the prior art.

One such device is U.S. Patent Application Publication No. 2011/0094494 to Malumyan, which discloses a portable combination gas and charcoal grill. Malumyan comprises a grill portion that is pivotally attached to a folding stand and that may alternately use either built-in gas burners or a charcoal tray to cook. Unlike Malumyan, the present invention allows individuals to cook with gas or charcoal heat sources simultaneously, rather than alternately.

Another such device is U.S. Pat. No. 4,827,903 to Kim, which discloses a table-mounted barbecue cooker with means for collecting smoke and grease. Kim utilizes a grease pan with troughs that is situated between the grill and the burners to catch grease dripping from food cooked on the grilling surface, preventing it from coming in contact with the heat source. The present invention also has a means for preventing drippings from food from coming in contact with the gas or electric heating element, however it additionally utilizes a charcoal or wood heating element and the grease tray is angled so that the grease collects in a removable grease receptacle for easy cleaning.

U.S. Pat. No. 5,878,739 to Guidry discloses a combination gas and charcoal grill having a burner that is vertically adjustable. Guidry further includes a deflector pan that sits above the burners to prevent food or drippings from coming in contact with the burners and that can also be filled with water or charcoal. The present invention includes a grease tray for preventing food debris from coming in contact with the heat sources, a heat shield for deflecting the heat from the vertical heating element to generate indirect heat, and a charcoal tray, however in the present they are all separate elements that are independently removable so that they are easy to clean.

U.S. Pat. No. 6,705,307 to Alden discloses a removable gas burner unit for barbecue grills, allowing a grill to be used in two different cooking modes. The present invention integrally contains means for cooking by both gas and charcoal and does not require an additional removable piece to cook in a second mode.

The present invention is a new and improved combination gas and charcoal grill. The present invention allows users to simultaneously utilize a first heat source, comprising gas or electric burners, and a second heat source, comprising a means for holding wood, charcoal, and the like, to cook food on alternate portions of the grill surface. The present invention further comprises a grease tray that prevents food debris from coming in contact with the gas heating element to prevent flame ups and a heat shield to deflect the heat emanating from the vertical heating element so that the food on the grill surface is cooked by indirect heat from the vertical heating element. The present combination gas and charcoal grill may also include side burners, side tables, and other grill accessories. It substantially diverges in design elements from the prior art and consequently it is clear that there is a need in the art for an improvement to existing grill or barbecue devices. In this regard the instant invention substantially fulfills these needs.

### SUMMARY OF THE INVENTION

In view of the foregoing disadvantages inherent in the known types of grills or barbecues now present in the prior art, the present invention provides a new combination grill wherein the same can be utilized for providing convenience for the user when cooking food.

It is therefore an object of the present invention to provide a new and improved grill device that has all of the advantages of the prior art and none of the disadvantages.

It is another object of the present invention to provide a grill device that has integral means for simultaneously using charcoal or wood and gas or electric as heat sources to cook food.

Another object of the present invention is to provide a grill device that prevents food debris, such as grease, from coming in contact with the gas heating element.

Another object of the present invention is to provide a grill device that has a means to deflect heat emanating from the vertical heating element so that food is cooked via a combination of indirect heat from the vertical heating element and wood or charcoal.

Yet another object of the present invention is to provide a grill device that is easily cleaned.

Yet another object of the present invention is to provide a grill that is available in a wide variety of shapes, sizes, and configurations.

Yet another object of the present invention is to provide a grill that can be provided with gas burners and a charcoal tray having different surfaces areas.

Still yet another object of the present invention is to provide a grill that is portable.

Still yet another object of the present invention is to provide a grill that can be interchangeably be used in indoor and outdoor applications.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2A shows a side view of the internal components of the present invention, with the grill housing depicted in dotted lines.

FIG. 2B shows a front view of the internal components of the present invention, with the grill housing depicted in dotted lines.

FIG. 3 shows an exploded view of the internal components of the present invention.

FIG. 4 shows a perspective view of an alternative embodiment of the present invention.

FIG. 5 shows a perspective view of an alternative embodiment of the present invention.

FIG. 6 shows a perspective view of an alternative embodiment of the present invention.

### DETAILED DESCRIPTION OF THE INVENTION

Reference is made herein to the attached drawings. Like reference numerals are used throughout the drawings to depict like or similar elements of the combination grill. For the purposes of presenting a brief and clear description of the present invention, the preferred embodiment will be discussed as having the vertical heating element disposed along the interior back surface of the grill housing and as used for cooking outdoors. The figures are intended for representative purposes only and should not be considered to be limiting in any respect.

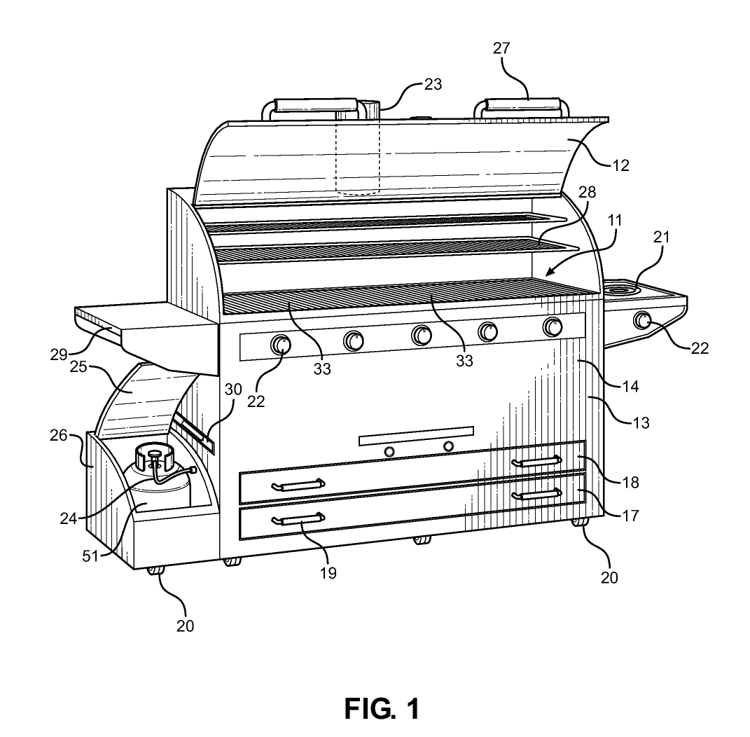

Referring now to FIG. 1, there is shown a perspective view of the present invention. The present combination gas and charcoal grill comprises a traditional grill housing 13 with a grill surface 11, a grill lid 12, and a pair of heat sources for heating the grill surface 11 so that food may be cooked thereon. The grill surface 11 comprises a plurality of spaced, preferably cylindrical bars 33 composed of a highly thermally-conductive metallic material. Although the grill bars 33 are preferably cylindrical, the grill bars 33 may be in the shape of a triangular prism, a rectangular prism, or any elongated other shape suitable for supporting food. The bars of the grill surface 11 are suspended between opposing sides of the housing 11 such that they extend across the opening in the housing 13 above the internal components of the grill and in aggregate create a substantially planar surface on which to cook food. Heat is transferred from the heat sources, to the grill surface 11, which then transfers the heat to the food placed thereon.

The present invention utilizes a combination of a vertical heating element, disposed on the interior surface of the back sidewall of the grill housing 13 and a horizontal heating element for heating the grill surface 11. The vertical heating element may be provided in either gas, such as propane, or electric embodiments. The horizontal heating element 18 comprises a removable tray that is capable of supporting either wood or charcoal. The horizontal heating element 18 is substantially parallel to the grill surface 11 and preferably includes at least one heat-shielded handle 19. The vertical heating element of the present invention comprises conventional gas burners or electrically-heated coils that are held in a fixed, suspended position within the back portion of the interior of the grill housing 13. No claim is made as to the precise configuration or design of the heating elements, except that vertical heating element is substantially perpendicular to the grill surface 11 and the horizontal heating element is substantially parallel to the grill surface 11.

For embodiments of the present invention in which the vertical heating element is a series of gas burners, the vertical heating element is fed via a gas line 24, which is attached to a gas tank 51. The gas tank 51 is a conventional refillable gas tank and is not an element of the present invention. The present invention utilizes traditional combustible gas, such as propane. The gas line 24 is removably affixed to the gas tank 51 via any type of temporary fastening means, such as threading adapted to engage with complementary threading on the gas tank 51 top or a clamp. A plurality of control knobs 22 disposed on the exterior surface of the grill housing 13 control the flow of gas through the gas line 24 and therefore the intensity of the flame generated therefrom. For embodiments of the present invention in which the vertical heating element is a series of electrically-heated coils, the grill housing has a plug extending therefrom (not shown) that is adapted to engage with a conventional two or three-prong electrical outlet.

The horizontal heating element 18 of the present invention comprises a rigid planar member slidably supported within the grill housing 13. The horizontal heating element 18 is adapted to hold smoldering charcoal briquettes or wood beneath the grill surface 11 in order to heat said surface 11. The charcoal tray 18 is designed so that it is easily removable so that charcoal can be easily placed on it and so that it can be cleaned with minimal effort by the user. The charcoal tray 18 is preferably supported in a substantially horizontal position within the grill housing 13 by a pair of rails engaged with complementary portions on the elongated edges of the horizontal heating element 18. The horizontal heating element 18 is capable of supporting charcoal briquettes, lump charcoal, or various types of wood suitable to grill or smoke with. The horizontal heating element 18 is composed of stainless steel or another such material capable of withstanding the heat generating by the charcoal briquettes, wood, or other heat sources placed thereon.

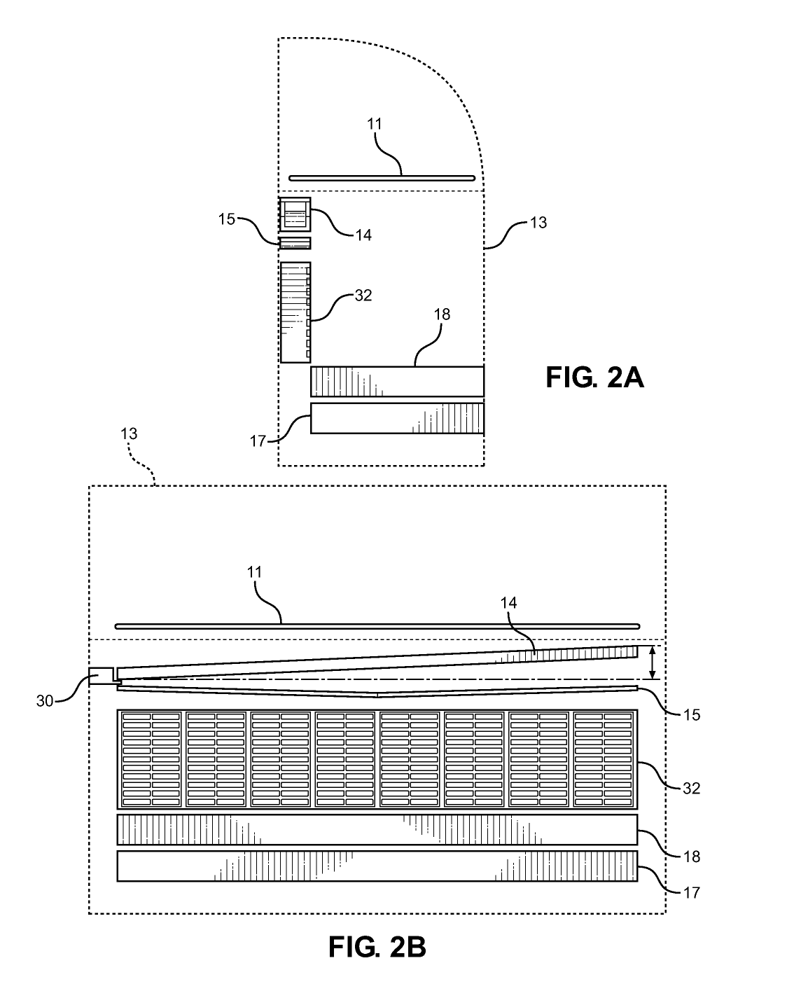

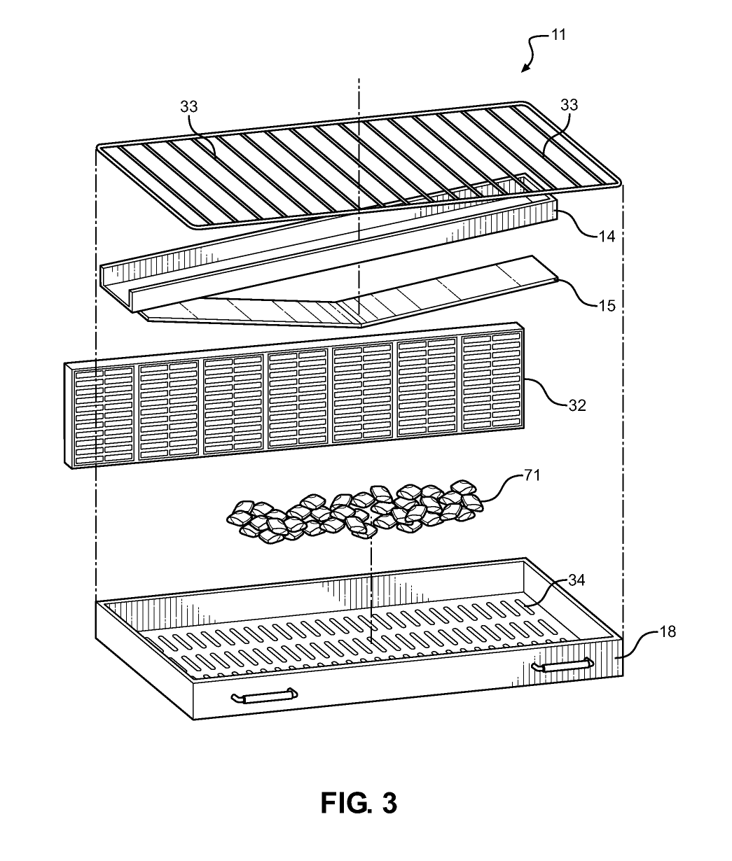

Referring now to FIGS. 2A, 2B, and 3, there are shown various views of the internal components of the present invention. The present invention utilizes both a vertical heating element 32 and a horizontal heating element 18 disposed within the interior of the grill housing 13. The vertical heating element 32 is affixed to the interior surface of the back sidewall of the grill housing 13 and is oriented perpendicularly to the grill surface 11. The vertical heating element 32 comprises a series of gas burners or electrically-heated coils, preferably disposed in a plurality of aligned rows to generate consistent, even heat therefrom. The intensity of the heat generated by the vertical heating element 32 is adjustable by the user, preferably by a series of control knobs, or other similar adjustment means, disposed on the front exterior of the grill housing 13. In one embodiment of the present invention, the entire vertical heating element 32 is adjustable as a single unit. In an alternate embodiment of the present invention, the vertical heating element 32 has a series of regions, which are each independently adjustable by a corresponding control knob or other adjustment means.

Because the vertical heating element 32 is disposed on the back surface of the interior of the grill housing 13, it is able to generate a corresponding region on the back of the grill surface 11 where the level of heat is independently adjustable from the front region of the grill surface 11, which is heated primarily by the horizontal heating element 18. Therefore, users can cook food slowly on the front of the grill surface 11 or turn up the heat generated by the vertical heating element 32 and move the food to the back portion of the grill surface 11 and cook it quickly at high heat. In alternative embodiments of the present invention, the vertical heating element 32 is disposed on the side sidewalls of the grill housing 13 or the front sidewall of the grill housing 13, changing the corresponding region of the grill surface 11 that is heated by the vertical heating element 32.

The horizontal heating element 18 comprises a removable tray slidably disposed within the bottom portion of the grill housing 13, substantially parallel to the grill surface 11. The horizontal heating element 18 comprises a planar tray suitable for supporting smoldering charcoal briquettes, wood, or other fuel heat sources and a series of sidewalls extending around the perimeter of the tray to preventing the material supported thereon from falling off when in use. In the preferred embodiment, the horizontal heating element 18 has a series of slits 34 so that as the charcoal or wood burns, the ash generated therefrom falls down into the ash tray 17 oriented beneath the horizontal heating element 18. In the preferred embodiment of the present invention, the horizontal heating element 18 is located one foot and six inches below the grill surface 11 in order to properly balance the level of heat received by the grill surface 11 from the horizontal heating element 18. However, no claim is made as to the precise distance between the grill surface 11 and the horizontal heating element 18.

When used in tandem, the vertical heating element 32 and the horizontal heating element 18 allow users to create a temperature and flavor gradient on the grill surface 11. If users wish to cook food at lower temperatures with more charcoal or smoke flavor, then they can place their food on the front portion of the grill surface 11. If users wish to cook their food at higher temperatures with less charcoal or smoke flavor, then they can place their food along the back portion of the grill surface 11. This temperature gradient is especially useful for foods that must be cooked at different temperatures depending upon the stage of the cooking process, such as jerk chicken.

A catch pan 14 is disposed between the vertical heating element 32 and the grill surface 11. The catch pan 14 comprises a substantially rigid, planar member held in a fixed, angled position within the grill housing 13. In one embodiment of the present invention, the catch pan 14 is slidably disposed within the grill housing by a pair of rails engaging with complementary portions along the elongated edges of the planar member. In an alternative embodiment of the present invention, the catch pan 14 is permanently affixed to the interior of the grill housing 13. The catch pan 14 is adapted to catch grease and other food debris that falls through the bars 33 of the grill surface 11, preventing it from coming in contact with the vertical heating element 32. It is undesirable for grease and other food particles to come in contact with the vertical heating element 32 because if the vertical heating element 32 utilizes gas burners, then the grease can cause flare ups.

The catch pan 14 is preferably angled to direct the caught material to the catch receptacle 30, which is disposed along the grill housing 13. The catch receptacle 30 comprises a member having a plurality of sidewalls and a base, creating a bin or container for temporarily holding material from the catch pan 14. The lowest edge of the catch pan 14 lacks a sidewall, allowing grease to flow from the catch pan 14 to the catch receptacle 30 situated below that edge. The angled catch pan 14 may be disposed at any angle and in a number of different shapes. In an alternative embodiment of the present invention (not shown), the catch pan 14 is configured in an inverted “V” shape and directs falling food debris into a pair of catch receptacles 30 placed at opposite sides of the grill housing 13, rather than a single catch receptacle 30. Both the catch pan 14 and the catch receptacle 30 are freely removable and preferably composed of non-stick material to make them easy to clean.

An alternative embodiment of the present invention further has a heat shield 15 disposed between the catch pan 14 and the vertical heating element 32. The heat shield 15 is designed to deflect the heat emanating from the vertical heating element 32 so that only indirect heat substantially reaches the grill surface 11. Only cooking food via indirect heat from the vertical heating element 32 helps to ensure that food does not become burned or overcooks to quickly due to being exposed directly to flames. The heat shield 15 is preferably composed of a variety of different types of materials capable of deflecting heat, including galvanized steel, ceramic stone, porcelain, and other such materials. The opposing ends of the heat shield 15 are connected to opposing sides of the housing 13, holding the heat shield 15 in a rigid, fixed position above the vertical heating element 32. As depicted, the heat shield 15 roughly has an obtuse-angled “V” shape, however no claim is made as to the specific shape or orientation of the heat shield 15. However, certain shapes, such as the depicted “V” shape, are more ideally suited to deflecting heat. The heat shield 15 is designed to only cover the vertical heating element 32 for safety and heat controllability reasons. It is otherwise desirable for grease and other food particles to drop through the grill surface 11 onto the charcoal 71 or wood below, because such dripping fat vaporizes and further acts to enhance the flavor of the food being cooked.

In an alternative embodiment of the present invention, the device does not have a separate heat shield 15 and catch pan 14. In this embodiment, the catch pan 14, or at least the bottom surface of the catch pan 14, is composed of heat deflecting material, such as galvanized steel, ceramic stone, porcelain, and other such materials, thereby allowing the angled catch pan 14 itself to serve as the heat shield. The catch pan 14 in this embodiment may be disposed at a number of different angles and in a number of different shapes, allowing both for heat to be deflected and for falling food debris to be directed towards a catch receptacle or receptacles 30.

An ash tray 17 is disposed within the grill housing 13, substantially parallel to and beneath the horizontal heating element 18. The ash tray 17, like the horizontal heating element 18 and the catch pan 14, is a substantially rigid, planar member held in a fixed position within the grill housing 13, preferably by a pair of rails extending between opposing sidewalls of the grill housing 13 that are adapted to engage with complementary portions along the elongated edges of the planar member. The ash tray 17 is adapted to catch ash, debris, and other heavier-than-air particulate matter generated by the charcoal or wood as it burns and falls through the series of slits 34 in the horizontal heating element 18. Like the horizontal heating element 18 and the catch pan 14 of certain embodiments, the ash tray 17 is designed such that it is easily removed and cleaned by users and is therefore composed of material that is resistant to damage from being washed within a dishwashing machine. The ash tray 17, horizontal heating element 18, and catch pan 14 (for embodiments in which it is removable) all have handles 19 extending from their exterior surfaces flush against the exterior surface of the grill housing 13. The handles 19 are designed such that a minimal amount of heat is transferred between the various trays 14, 17, 18 and the handles 19, allowing users to remove the various trays 14, 17, 18 without having to risk burning themselves. The handles 19 are composed of heat-resistant or heat-shielded material.

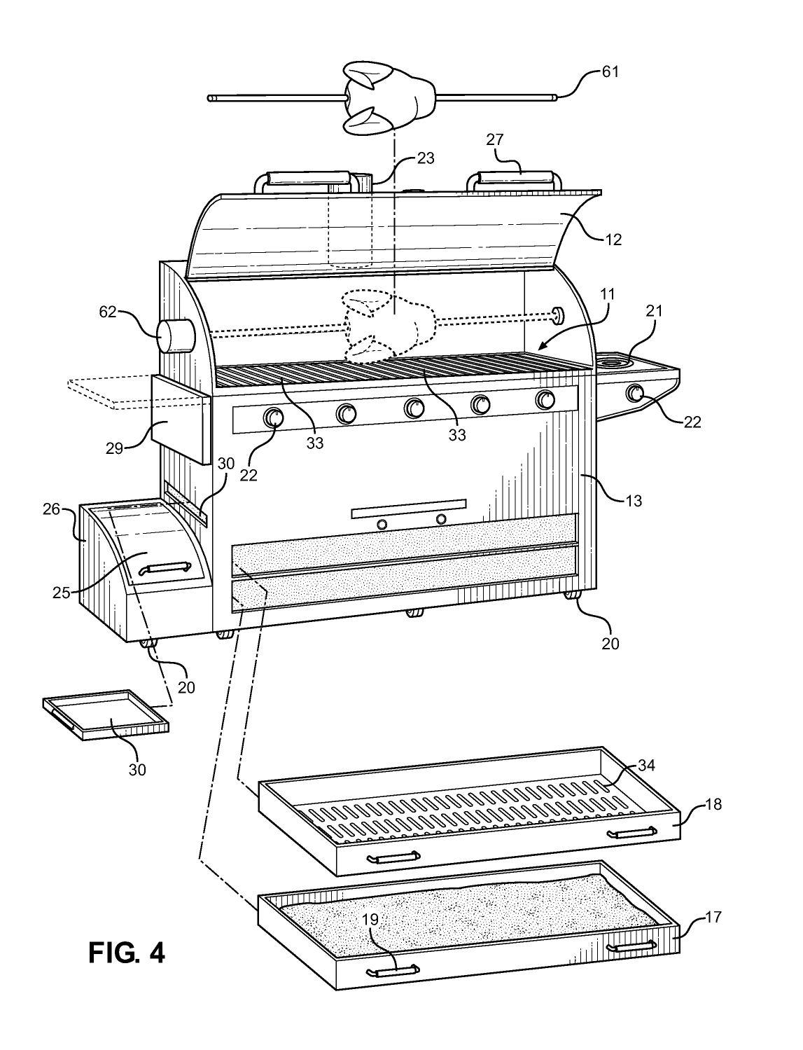

Referring now to FIG. 4, there is shown an alternative embodiment of the present invention. The present combination grill also preferably has a plurality of wheels 20 disposed on the bottom surface of the grill housing 13, making the entire device transportable. The wheels 20 are composed of sturdy material capable of withstanding the potentially substantial amount of weight of the present invention and are rotatably connected to the grill housing 13 in any conventional manner that is known in the prior art. In a preferred embodiment, the wheels 20 have a locking mechanism that be used to secure the wheels in place so that the present combination grill does not roll away or otherwise shift during use when not desired by the user.

The grill lid 12 is hingedly attached to the grill housing 13, allowing the lid 12 to transition between a lowered position in which the grill surface 11 is fully enclosed and a raised position in which the grill surface 11 is exposed. The grill lid 12 may be composed of a single hingedly attached portion or it may have multiple lid portions, alternately allowing various portions of the surface area of the grill surface 11 to be exposed. The grill lid 12 further preferably has a smoke pipe 23 extending therefrom, allowing smoke generated from the cooking of the food or the burning of the charcoal to escape and not be confined within the interior volume of the present invention defined by the grill lid 12 and the grill housing 13. In an alternative embodiment of the present invention, the present invention can be configured for indoor use by having the smoke pipe 23 connect with a complementary exhaust line or vent within the indoor environment.

The present invention may further include a number of different accessories common to conventional grills, including a foldable side accessible table 29, a side burner 21 preferably heated via gas, at least one secondary rack 28 (as seen in FIG. 1) for holding food elevated from the grill surface 11, and a gas tank holder 24. The gas tank holder 24 is designed to removably hold a gas tank 51 in place next to the grill housing 13, preventing the gas tank 51 or the gas line 24 from being interfered with. The gas tank holder 24 has a holder lid 25 for protecting the gas tank 51 from small children, the elements, and other hazards commonly associated with combustible gasses such as propane. In the depicted alternative embodiment of the present invention, the combination grill further includes a spit 61 removably mounted within the grill housing 13, above the grill surface 11. In a further alternative embodiment, the spit 61 is driven by an attached motor 62, which automatically rotates the food disposed thereon to cook said food in an ideal manner.

The present invention is preferably designed for outdoor use, however an alternative embodiment of the present invention is designed for indoor use, especially for large-scale commercial applications. In this embodiment, the gas line 24 is directly connected to a gas line within a building, providing the present device with a steady stream of gas, and the smoke pipe 23 is fed directly into the building's exhaust system. The present invention can thereby be used to cook food indoors without any risk that a substantial amount of smoke will spill into the surrounding interior of the building and choke users.

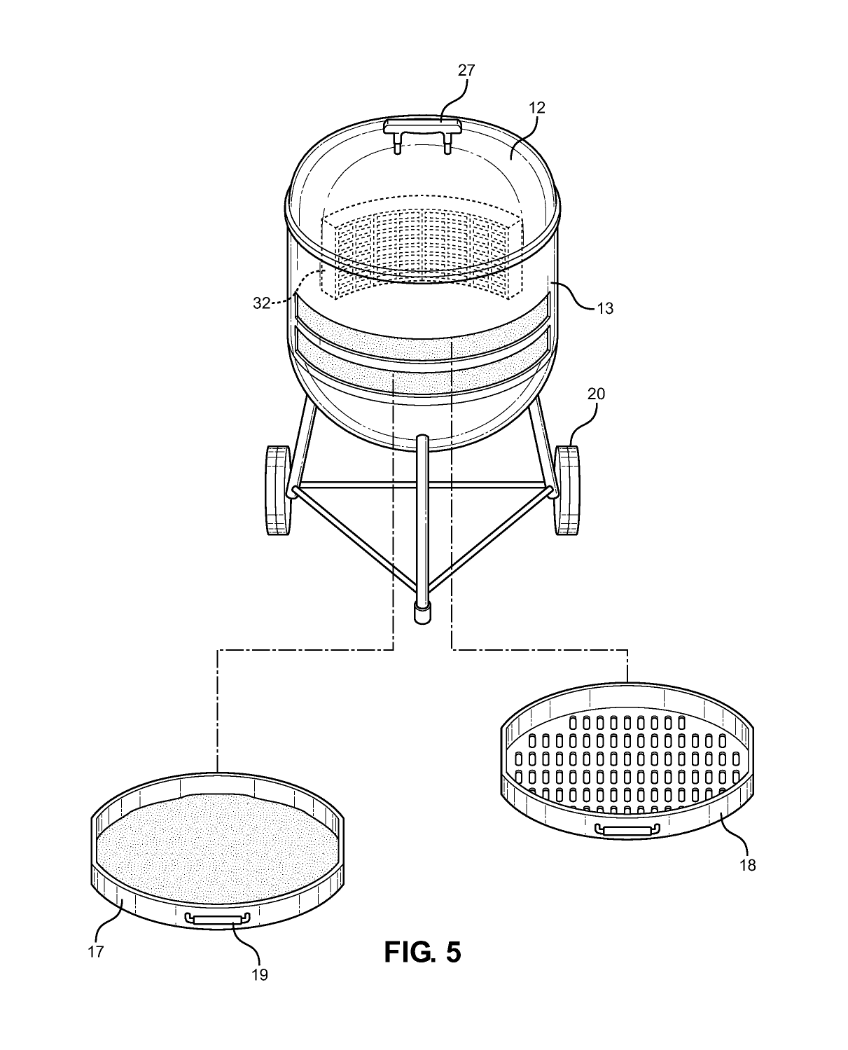

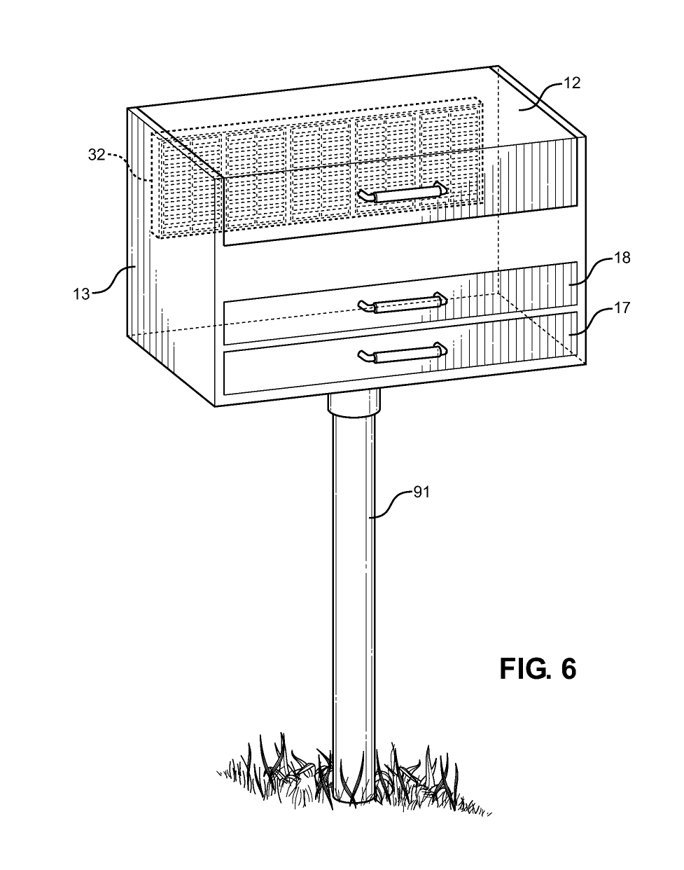

Referring now to FIGS. 5 and 6, there are shown perspective views of alternative embodiments of the present invention. The novel concepts of the present invention can be translated into grill housings 13 in any type of shape and configuration. The vertical heating element 32 and horizontal heating element 18 of the present invention can be configured in any way to complement said grill housing 13 shape. These alternative embodiments otherwise have all of the other elements of the present invention as disclosed above, including a hingedly attached or removable lid 12, a grill surface, a vertical heating element 32, a removable horizontal heating element 18, a catch pan, and other optional elements such as the heat shield and the ash tray 17.

In the embodiment depicted in FIG. 5, the grill housing 13 has a circular cross section and the vertical heating element 32 and horizontal heating element 18 have corresponding semicircular shapes. The proportional surface area covered by each of the heating elements 18, 32 can be altered to create different embodiments of the present invention where the grill surface 11 is heated in different proportions by each of the heating elements 18, 32. Additional embodiments of the present invention are contemplated in which the grill housing is triangularly shaped, rectangularly shaped, or has any other shape. No claim is made as to the precise shape of the grill housing 13, grill surface 11, and heating surface 61.

In the embodiment depicted in FIG. 6, the grill housing 13 has a substantially rectangular shape and is specifically adapted for use in outdoor park applications. In place of wheels, this embodiment of the present invention is permanently affixed to its base via a vertical support. As with the embodiment discussed above, this alternative embodiment otherwise has all of the other elements of the present invention as disclosed above, including a hingedly attached or removable lid 12, a grill surface, a vertical heating element 32, a removable horizontal heating element 18, a catch pan, and other optional elements such as the heat shield and the ash tray 17.

The present invention is designed to be versatile and allows users to cook food on the grill in a variety of different ways. An individual can choose whether to use the vertical heating element separately, use the horizontal heating element separately, or use both in tandem to create different areas on the grill surface that are heated primarily by each of the different heat sources. When used in tandem, the heating elements create a temperature and a flavor gradient on the grill surface. An individual uses the horizontal heating element simply by sliding it from the grill housing, placing smoldering charcoal or wood thereon, and then sliding the heating element back into the housing. The horizontal heating element will then heat the corresponding area on the grill surface situated parallel to it. The vertical heating element can simply be turned on and adjusted via a series of control knobs disposed on the exterior surface of the grill housing. Whether it is an embodiment of the present invention utilizing an electrical or a gas vertical heating element, the vertical heating element functions in substantially the same manner. The proportional surface area that the vertical heating element and the horizontal heating element can take up may be altered between different embodiments of the present invention. The catch receptacle, catch pan, ash tray, and horizontal heating element of the present invention may be freely slidably removed from the grill housing to be cleaned.

The present invention is otherwise used as a conventional grill for cooking food, except that different regions of the grill surface are simultaneously heated by different heat sources, creating different regions on the grill surface and allowing users to move food between the different regions depending upon the needs of that particular type of food. If users wish to impart a charcoal flavor to their food, then they can place their food in a region of the grill surface heated by the horizontal heating element, i.e. the front region of the grill surface as depicted in the FIG. 1f users wish instead to use gas to cook their food, either because they wish to have a more neutral flavor or want to control the level of heat more directly, then they can move their food to a region of the grill surface heated by the vertical heating element, i.e. the back region of the grill surface as depicted in the FIGs.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A combination grill having multiple heating elements, comprising:
a grill housing having an interior surface, an exterior surface, at least one lid, a grill surface, and a catch pan;
a vertical heating element disposed on said interior surface, substantially perpendicular to said grill surface;
a horizontal heating element disposed within said grill housing, substantially parallel to said grill surface;
wherein said catch pan is disposed between said vertical heating element and said grill surface, such that said catch pan substantially covers said vertical heating element but leaves said horizontal heating element substantially uncovered.

2. The combination grill having multiple heating elements of claim 1, further comprising:
a heat shield disposed within said grill housing between said vertical heating element and said catch pan;
said heat shield adapted to deflect heat such that said grill surface substantially receives indirect heat from said heat surface.

3. The combination grill having multiple heating elements of claim 2, wherein said heat shield is composed of galvanized steel.

4. The combination grill having multiple heating elements of claim 2, wherein said heat shield is composed of ceramic material.

5. The combination grill having multiple heating elements of claim 1, wherein said catch pan is removable.

6. The combination grill having multiple heating elements of claim 1, wherein said horizontal heating element is removable.

7. The combination grill having multiple heating elements of claim 1, further comprising:
a smoke pipe extending from said grill housing;
said smoke pipe adapted to allow smoke to exhaust from said grill housing interior volume.

8. The combination grill having multiple heating elements of claim 1, wherein said catch pan is disposed within said grill housing at an angle and adapted to empty into a catch receptacle.

9. The combination grill having multiple heating elements of claim 8, wherein said catch receptacle is removable.

10. The combination grill having multiple heating elements of claim 1, further comprising a plurality of wheels disposed on said grill housing.

11. The combination grill having multiple heating elements of claim 1, wherein said vertical heating element comprises a plurality of gas burners.

12. The combination grill having multiple heating elements of claim 11, further comprising a gas tank holder adapted to hold a gas tank connectable to said gas burners.

13. The combination grill having multiple heating elements of claim 1, wherein said vertical heating element comprises a plurality of electrically-heated coils.

14. The combination grill having multiple heating elements of claim 1, further comprising a side burner disposed on said grill housing.

15. The combination grill having multiple heating elements of claim 1, wherein said catch pan has a non-stick surface coating.

16. The combination grill having multiple heating elements of claim 1, wherein said catch receptacle has a non-stick surface coating.
